(19) United States
(12) Patent Application Publication
(10) Pub. No.: US 2024/0172026 A1
(43) Pub. Date: May 23, 2024

(54) REPORTING STATISTICAL CHANNEL STATE INFORMATION IN A REPORT

(71) Applicant: Lenovo (Singapore) Pte. Ltd., New Tech Park (SG)

(72) Inventors: Hossein Bagheri, Urban, IL (US); Hyejung Jung, Northbrook, IL (US); Ankit Bhamri, Rödermark (DE); Alexander Johann Maria Golitschek Edler von Elbwart, Darmstadt (DE); Vijay Nangia, Woodridge, IL (US)

(21) Appl. No.: 18/551,026

(22) PCT Filed: Mar. 18, 2022
(86) PCT No.: PCT/IB2022/052504

§ 371 Date: Sep. 18, 2023

Related U.S. Application Data
(60) Provisional application No. 63/162,873, filed on Mar. 18, 2021.

(51) Int. Cl. H04W 24/10; H04W 24/08

(52) U.S. Cl. CPC H04W 24/10; H04W 24/08

(57) ABSTRACT

Apparatuses, methods, and systems are disclosed for reporting statistical channel state information in a report. One method includes receiving, at a user equipment, an indication to report statistical channel state information (CSI). The method includes measuring CSI on a set of CSI measurement resources. The method includes determining the statistical CSI based on the CSI measurements on the set of CSI measurement resources. The method includes determining whether the statistical CSI is reliable, available, or a combination thereof. The method includes, in response to determining that the statistical CSI is reliable, available, or the combination thereof, including the statistical CSI in a CSI report. The method includes reporting the CSI report in an uplink (UL) transmission. The statistical CSI includes CSI statistics of CSI measurements measured on the CSI measurement resources.

### CROSS-REFERENCE TO RELATED APPLICATIONS

This application claims priority to U.S. Patent Application Ser. No. 63/162,873 entitled “APPARATUSES, METHODS, AND SYSTEMS FOR STATISTICAL CSI REPORTING FOR URLLC OPERATION” and filed on Mar. 18, 2021 for Hossein Bagheri, which is incorporated herein by reference in its entirety.

### FIELD

The subject matter disclosed herein relates generally to wireless communications and more particularly relates to reporting statistical channel state information in a report.

### BACKGROUND

In certain wireless communications networks, statistical information may be used. In such networks, a UE may be unaware of certain transmission parameters.

### BRIEF SUMMARY

Methods for reporting statistical channel state information in a report are disclosed. Apparatuses and systems also perform the functions of the methods. One embodiment of a method includes receiving, at a user equipment, an indication to report statistical channel state information (CSI). In some embodiments, the method includes measuring CSI on a set of CSI measurement resources. In certain embodiments, the method includes determining the statistical CSI based on the CSI measurements on the set of CSI measurement resources. In various embodiments, the method includes determining whether the statistical CSI is reliable, available, or a combination thereof. In some embodiments, the method includes, in response to determining that the statistical CSI is reliable, available, or the combination thereof, including the statistical CSI in a CSI report. In certain embodiments, the method includes reporting the CSI report in an uplink (UL) transmission. The statistical CSI includes CSI statistics of CSI measurements measured on the CSI measurement resources.

One apparatus for reporting statistical channel state information in a report includes a user equipment. In some embodiments, the apparatus includes a receiver that receives an indication to report statistical channel state information (CSI). In various embodiments, the apparatus includes a processor that: measures CSI on a set of CSI measurement resources: determines the statistical CSI based on the CSI measurements on the set of CSI measurement resources: determines whether the statistical CSI is reliable, available, or a combination thereof: and, in response to determining that the statistical CSI is reliable, available, or the combination thereof, includes the statistical CSI in a CSI report. In certain embodiments, the apparatus includes a transmitter that reports the CSI report in an uplink (UL) transmission. The statistical CSI includes CSI statistics of CSI measurements measured on the CSI measurement resources.

Another embodiment of a method for reporting statistical channel state information in a report includes transmitting, from a network device, an indication to report statistical channel state information (CSI). In some embodiments, the method includes receiving a CSI report in an uplink (UL) transmission. The CSI report includes statistical CSI based on the statistical CSI being determined to be reliable, available, or a combination thereof, and the statistical CSI is determined based on CSI measurements on a set of CSI measurement resources.

Another apparatus for reporting statistical channel state information in a report includes a network device. In some embodiments, the apparatus includes a transmitter that transmits an indication to report statistical channel state information (CSI). In various embodiments, the apparatus includes a receiver that receives a CSI report in an uplink (UL) transmission. The CSI report includes statistical CSI based on the statistical CSI being determined to be reliable, available, or a combination thereof, and the statistical CSI is determined based on CSI measurements on a set of CSI measurement resources.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for reporting statistical channel state information in a report:

FIG. 2 is a schematic block diagram illustrating one embodiment of an apparatus that may be used for reporting statistical channel state information in a report:

FIG. 3 is a schematic block diagram illustrating one embodiment of an apparatus that may be used for reporting statistical channel state information in a report:

FIG. 4 is a timing diagram illustrating one embodiment of a CSI reference resource for CSI report including CSI statistics being before a CSI reference resource of a CSI report not including CSI statistics:

FIG. 5 is a flow chart diagram illustrating one embodiment of a method for reporting statistical channel state information in a report: and

FIG. 6 is a flow chart diagram illustrating another embodiment of a method for reporting statistical channel state information in a report.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment.” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

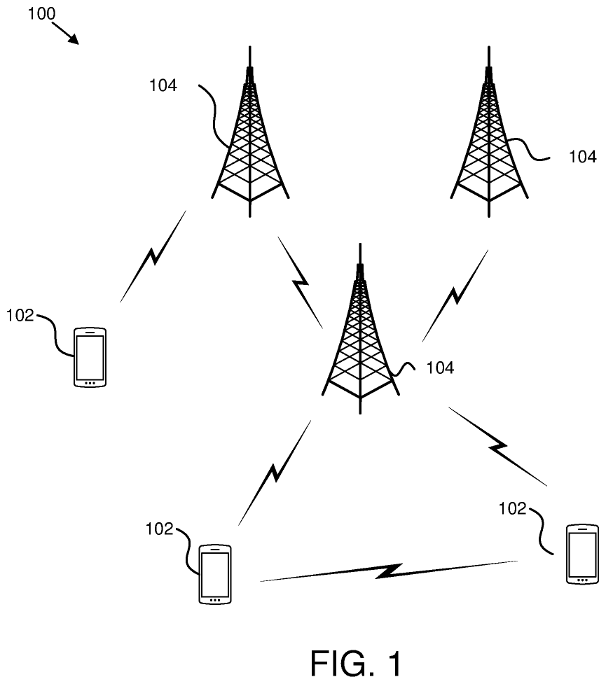

FIG. 1 depicts an embodiment of a wireless communication system 100 for reporting statistical channel state information in a report. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“cNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive, at a user equipment, an indication to report statistical channel state information (CSI). In some embodiments, the remote unit 102 may measure CSI on a set of CSI measurement resources. In certain embodiments, the remote unit 102 may determine the statistical CSI based on the CSI measurements on the set of CSI measurement resources. In various embodiments, the remote unit 102 may determine whether the statistical CSI is reliable, available, or a combination thereof. In some embodiments, the remote unit 102 may, in response to determining that the statistical CSI is reliable, available, or the combination thereof, include the statistical CSI in a CSI report. In certain embodiments, the remote unit 102 may report the CSI report in an uplink (UL) transmission. The statistical CSI includes CSI statistics of CSI measurements measured on the CSI measurement resources. Accordingly, the remote unit 102 may be used for reporting statistical channel state information in a report.

In certain embodiments, a network unit 104 may transmit, from a network device, an indication to report statistical channel state information (CSI). In some embodiments, the network unit 104 may receive a CSI report in an uplink (UL) transmission. The CSI report includes statistical CSI based on the statistical CSI being determined to be reliable, available, or a combination thereof, and the statistical CSI is determined based on CSI measurements on a set of CSI measurement resources. Accordingly, the network unit 104 may be used for reporting statistical channel state information in a report.

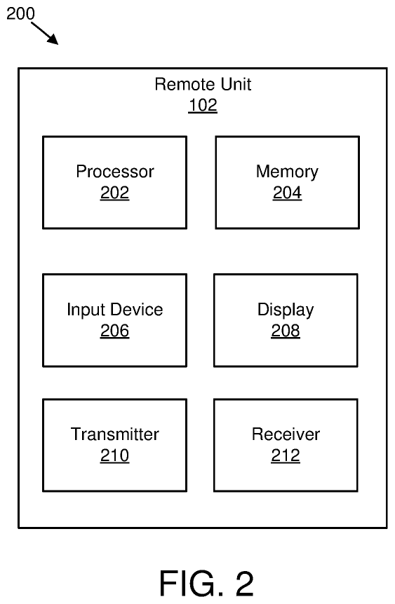

FIG. 2 depicts one embodiment of an apparatus 200 that may be used for reporting statistical channel state information in a report. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 receives an indication to report statistical channel state information (CSI). In various embodiments, the processor 202: measures CSI on a set of CSI measurement resources; determines the statistical CSI based on the CSI measurements on the set of CSI measurement resources: determines whether the statistical CSI is reliable, available, or a combination thereof: and, in response to determining that the statistical CSI is reliable, available, or the combination thereof, includes the statistical CSI in a CSI report. In certain embodiments, the transmitter 210 reports the CSI report in an uplink (UL) transmission. The statistical CSI includes CSI statistics of CSI measurements measured on the CSI measurement resources.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

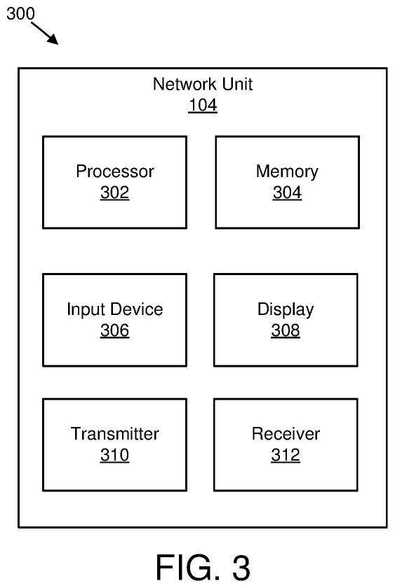

FIG. 3 depicts one embodiment of an apparatus 300 that may be used for reporting statistical channel state information in a report. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 transmits an indication to report statistical channel state information (CSI). In various embodiments, the receiver 312 receives a CSI report in an uplink (UL) transmission. The CSI report includes statistical CSI based on the statistical CSI being determined to be reliable, available, or a combination thereof, and the statistical CSI is determined based on CSI measurements on a set of CSI measurement resources.

It should be noted that one or more embodiments described herein may be combined into a single embodiment.

In certain embodiments, statistical channel state information (“CSI”) such as mean, variance, percentile, and so forth can be reported by a user equipment (“UE”) to the network, which could facilitate modulation and coding scheme (“MCS”) selection at a gNB, particularly as the UE is unaware of the transmission parameters of a to-be-scheduled physical downlink shared channel (“PDSCH”) such as transport block size (“TBS”), block error rate (“BLER”) target, and so forth for deriving CSI feedback such as a channel quality indicator (“CQI”) index.

In some embodiments, there may be mechanisms to determine statistical CSI information, including: a) procedures to determine and/or indicate the CSI statistics are not available and/or reliable: b) determining a minimum number of required signal to interference and noise ratio (“SINR”) samples, CQI samples, and/or CSI reference signal (“RS”) (“CSI-RS”) transmission occasions to provide sufficiently reliable statistical information: c) procedures to determine and remove outliers: and/or d) CSI feedback content to represent mean and variance of the SINR and/or CQI.

In various embodiments, CSI is used by a network to adjust downlink (“DL”) transmission parameters for UEs. In such embodiments, CSI is reported by the UEs to the network, and the reporting can be in a periodic, a semipersistent, or a-periodic manner. In periodic reporting, a UE reports CSI to the network periodically with a configured reporting periodicity. Semi-persistent CSI reporting is similar to the periodic reporting with a difference that CSI reporting can be activated and/or deactivated by downlink control information (“DCI”) for semi-persistent CSI reporting on a physical uplink shared channel (“PUSCH”) or activated and/or deactivated by a medium access control (“MAC”) control element (“CE”) (“MAC-CE”) for semi-persistent CSI reporting on a physical uplink control channel (“PUCCH”). A-periodic CSI (“A-CSI”) reporting is triggered by DCI. In certain new radio (“NR”) specifications, a-periodic reporting is triggered by an uplink (“UL”) DCI, and the CSI report is transmitted on an UL data channel (e.g., PUSCH). In certain embodiments, a downlink DCI trigger enables a CSI report to be carried on a PUCCH.

In some embodiments, statistical CSI can include a percentile (e.g., of SINR, or CQI corresponding to a cumulative distribution function (“CDF”), and/or a probability distribution function (“PDF”)), a mean, a variance, a standard deviation, a median of CQI corresponding to (e.g., post decoding) SINR samples, and so forth. In various embodiments, a UE to report statistical CSI to a gNB may be enabled to help the gNB select a proper MCS by having an understanding of channel, interference, and/or SINR profile and/or distribution. The gNB may be able to get such understanding using existing CSI procedures (e.g., without UE reporting a new CSI quantity providing statistical CSI information via configuring frequent (regular CSI reporting and/or non-statistical CSI reporting instead of configuring statistical CSI). In such CSI procedures, frequent CSI reporting may result in large overhead.

In certain embodiments, for statistical CSI reporting, CQI can be computed at several instances within a period assuming rank indicator (“RI”) and/or precoder matrix indicator (“PMI”) are fixed within the period.

In some embodiments, CSI statistics can be reported separately or along with other CSI feedback. In various embodiments, a CSI reference resource determines a latest CSI resource that a UE can use to derive CSI quantity for reporting CSI on a given UL slot.

In certain embodiments, instead of slot, mini-slot, subslot, or aggregated slots may also be used.

In some embodiments, standard deviation or variance may be used to describe statistical distribution of a plurality of samples. The standard deviation of a random variable, sample, statistical population, data set, or probability distribution is the square root of its variance. Therefore, one can be easily calculated from the other without loss of generality, so that reference to one of these should be understood as being equally applicable to the other with the appropriate mathematical conversion, where necessary. For example, to describe statistical properties, instead of obtaining or reporting the mean and standard deviation, an equivalent alternative is to obtain or report mean and variance (and vice versa).

In various embodiments, the terms CSI resources and CSI transmission occasions are used interchangeably.

In certain embodiments, there may be mechanisms to provide sufficiently reliable statistical CSI information.

In a first embodiment, CSI statistics may be not reliable and/or not available.

In some embodiments, a UE determines if CSI statistics are not available and/or reliable enough. In one example, the UE skips sending (e.g., on a PUCCH resource associated with periodic CSI reporting of CSI statistics) the CSI statistics or alternatively drops or omits the

CSI report associated with CSI statistics if they are not available and/or reliable enough. In another example, the UE indicates to and/or informs a gNB (e.g., in uplink control information (“UCI”) corresponding to the CSI statistics) about whether the CSI statistics are not available and/or reliable. In a further example, the UE indicates ‘out of range’ from a CQI table if the statistics are not available and/or reliable. In some examples, the UE multiplexes or indicates an indication ‘not available’ in a field of CSI statistics while reporting other CSI reporting quantities (e.g., CQI, PMI, and/or RI) as configured. In various examples, the UE determines that CSI statistics are not available and/or reliable enough by one or more conditions such as if: 1) the UE has not received at least ‘n’ CSI resources (e.g., due to a CSI resource overlapping with an uplink symbol, CSI resource pre-emption or the number of active CSI resources in a bandwidth part (“BWP”) for a given slot exceed UE capability) or has not obtained and/or calculated at least ‘n’ SINR and/or CQI samples (e.g., limitation on (e.g., no and/or fewer) number of unoccupied CSI processing units available for processing CSI (e.g., supported maximum number of CSI processing units for simultaneous CSI calculations is a UE capability), or on priority of CSI) within a time duration e.g., from/after the last (e.g., previous) instance of reporting CSI statistics (e.g., CSI report having a CSI statistics field and the CSI report having the same CSI report configuration index as that for which the CSI statistics is being determined) and no later than a CSI reference resource: 2) the UE has not received and/or obtained at least ‘n’ SINR. CQI samples, and/or ‘n’ CSI resources within a window of ‘T’ symbols, slots, and/or subslots—in an example, ‘n’ and/or ‘T’ are higher layer configured and/or specified—in another example, ‘T’ symbols are determined based on a numerology (e.g., subcarrier spacing) associated with the CSI-RS transmissions, wherein a mapping table can be configured between multiple values of the ‘T’ symbols and multiple values of numerologies—in a further example, a window duration may be determined from the first symbol of the earliest one of each CSI-RS, CSI interference management (“IM”) (“CSI-IM”), and/or synchronization signal block (“SSB”) resource for channel or interference measurement such that there are ‘n’ configured CSI-RS, CSI-IM, and/or SSB resources (e.g., not necessarily receiving all ‘n’ of the CSI-RS transmission occasion for channel measurement and CSI-RS and/or CSI-IM occasion for interference measurement) and the respective latest CSI-RS, CSI-IM, and/or SSB occasion no later than the corresponding CSI reference resource: 3) the UE may be considered as not receiving CSI resources if there is no valid downlink slot for the CSI reference resource corresponding to a CSI report setting in a serving cell and/or if CSI resources for channel measurements are not detectable (e.g. reference signal received power (“RSRP”) is below than a threshold value): 4) the UE has determined that a confidence measure associated with determined and/or estimated CSI statistics being below a threshold (e.g., higher confidence in higher value of the measure) or the UE has determined that there are outliers in the CSI samples (e.g., there are more than ‘x’ samples, more than y % of samples and so forth that are outliers) where the threshold or ‘x’/‘y’ can be defined in specifications or indicated such as by higher layer signaling): and/or 5) the UE has determined the interference and/or SINR distribution has changed (e.g., with respect to a previously determined or reported channel state information).

In various embodiments, a UE reports statistical CSI report (e.g., potentially along with other CSI report quantities such as CQI. PMI, and/or RI) only after receiving at least ‘n1’ CSI-RS transmission occasions for channel measurement and at least ‘n2’ transmission occasions for CSI-RS and/or CSI-IM occasion for interference measurement no later than a first CSI reference resource and drops the statistical CSI report otherwise or indicates the CSI report is not available and/or reliable. In one example, the first CSI reference resource is different than a second CSI reference resource, wherein the second CSI reference resource is determined for non-statistical CSI reports. In another example, the first CSI reference resource is determined based on an offset (e.g., with non-negative value) relative to the second CSI reference resource. In a further example, the first CSI reference resource is determined based on multiple second CSI reference resources. In certain examples, the second CSI reference resource is defined for non-statistical CSI reporting. In some examples, the number of multiple second CSI reference resources is fixed in specifications or indicated by higher layers.

In certain embodiments, after CSI report configuration and/or reconfiguration, serving cell activation, bandwidth part (“BWP”) change, or activation of semi-periodic (“SP”) CSI (“SP-CSI”), a UE reports statistical CSI report (e.g., potentially along with other CSI report quantities) only after receiving at least ‘n1’ CSI-RS transmission occasions for channel measurement and at least ‘n2’ transmission occasions for CSI-RS and/or CSI-IM occasion for interference measurement no later than a first CSI reference resource and drops the statistical CSI report otherwise or indicates that the CSI report is not available and/or reliable. In one example, ‘n1’ and/or ‘n2’ are fixed in the specifications and/or higher layer configured. One motivation for having ‘n1’ and ‘n2’ configurable by higher layer signaling is to let the gNB set those values based on channel and interference characteristics and/or profiles.

In some embodiments, in a time domain, a CSI reference resource for CSI reporting in uplink slot n′ is defined by a single downlink slot n-n_{CSI_ref}, where

$$n = ⌊ {n}^{′} \cdot \frac{{2}^{{μ}_{D L}}}{{2}^{{μ}_{DL}}} ⌋$$

and μ_{DL} and μ_{UL} are the subcarrier spacing configurations for DL and UL, respectively, and for periodic and semi-persistent CSI reporting: 1) if a single CSI-RS and/or SSB resource is configured for channel measurement, n_{CSI_ref} is the smallest value greater than or equal to 4·2^{μ}^{_{DL}} such that it corresponds to a valid downlink slot: 2) if multiple CSI-RS and/or SSB resources are configured for channel measurement, n_{CSI_ref} is the smallest value greater than or equal to 5·2^{μ}^{_{DL}}, such that it corresponds to a valid downlink slot: and/or 3) if multiple CSI-RS, SSB, and/or CSI-IM resources are configured for channel and/or interference measurement and if statistical CSI is to be reported, nest ref is the smallest value greater than or equal to m·2^{μ}^{_{DL}} such that it corresponds to a valid downlink slot, where ‘m’ is defined or higher layer signaled, and ‘m’ is different than 4 or 5. In one example, ‘m’ is larger than 5. In another example, ‘m’ depends on a processing capability of a UE regarding determining statistical CSI.

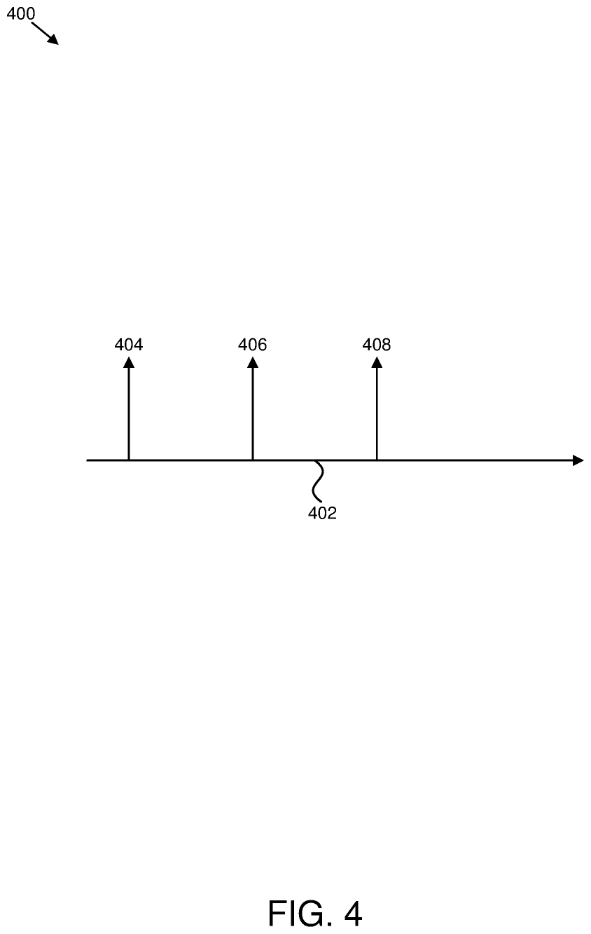

FIG. 4 shows an example where downlink slot n-n_{CSI_ref,a} corresponds to CSI report not containing CSI statistics and the downlink slot n-n_{CSI_ref,b} corresponds to CSI reports containing CSI statistics. Specifically, FIG. 4 is a timing diagram 400 illustrating one embodiment of a CSI reference resource for CSI report including CSI statistics being before a CSI reference resource of a CSI report not including CSI statistics. The timing diagram 400 includes a downlink slot n-n_{CSI_ref,a} 404, a downlink slot n-n_{CSI_ref,b} 406, and an uplink slot n′.

In various embodiments, a number (e.g., minimum number) of required SINR and/or CQI samples or CSI-RS and/or CSI-IM occasions (e.g., referred to as ‘n’, ‘n1’, and/or ‘n2’) may be derived by a UE (e.g., by calculating a confidence measure of the to be reported and/or already reported statistics), and if a minimum number is not received and/or available for the UE, the UE determines that the statistics are not available and/or reliable enough. In one example, a number of required CQI and/or SINR samples or CSI-RS and/or CSI-IM occasions for determining a standard deviation of SINR and/or CQI is determined such that the variance of the determined standard deviation is smaller than a threshold. In another example, the variance of the standard deviation ‘s’ is determined as an estimated and/or population variance σ² for a sample population of size ‘n’, and the threshold is set to be 0.01: therefore, n is determined to be at least ceil(2*σ⁴+1): where ceil(x) is the ceiling operation which maps ‘x’ to the least integer greater than or equal to ‘x’, i.e.,

$$Var [ {s}^{2} ] = Var ( \frac{{σ}^{2}}{n - 1} ) {x}_{n - 1}^{2} = \frac{{σ}^{4}}{{( n - 1 )}^{2}} Var ( {x}_{n - 1}^{2} ) = \frac{2 {σ}^{4}}{n - 1} \leq 0.01 .$$

In certain embodiments, if a configured and/or required number of samples are not available and/or received at a UE to determine reliable CSI statistics, then the UE can still report the CSI statistics determined on ‘m’ number of samples that is less than the configured and/or required ‘n’ number of samples and additionally indicate to the UE one or combination of the following: 1): 1-bit indicator to inform a gNB that a required number of samples was not available and the CSI statistics is based on a lesser number of samples: 2) a value of ‘m’ (or a function of ‘n’ and ‘m’ such as ratio ‘m’/‘n’) to inform the network about the actual number of samples used to calculate the CSI statistics: and/or 3) other information indicating a reliability level of the reported CSI statistics.

In some embodiments, a priority parameter is defined for CSI reports carrying statistical CSI (e.g., such as ‘k’ or ‘y’). The value of the priority parameter may be dependent on reliability and/or availability (e.g., a reliability indication or based on a derived reliability or based on whether the statistical CSI is available) of the statistical CSI report (e.g., statistical CSI report that is reliable enough has higher priority). In one example, k=0 for CSI report carrying a CSI statistics field. In another example, k=0 for CSI report carrying CSI statistics if the UE determines the CSI statistics are available and/or reliable, and k=1 for a CSI report carrying CSI statistics if the UE determines the CSI statistics are unavailable and/or unreliable. In some examples, a first CSI report is said to have priority over a second CSI report if the associated priority value is lower for the first report than for the second report. In various examples, two CSI reports are said to collide if the time occupancy of the physical channels scheduled to carry the CSI reports overlap in at least one orthogonal frequency division multiplexing (“OFDM”) symbol and are transmitted on the same carrier. If a UE is configured to transmit two colliding CSI reports, one of the following rules is applicable: 1) the CSI report with a lower or higher priority value shall not be sent by the UE: and/or 2) the two CSI reports are multiplexed or either is dropped based on the priority values associated with the CSI reports.

In various embodiments, a gNB instead of a UE determines if reported CSI statistics are not available and/or reliable enough.

In a second embodiment, CSI outliers may be determined.

In certain embodiments, a UE determines if a sample CQI and/or SINR is an outlier for the purpose of computing CSI statistics. An outlier is an observation that lies an abnormal distance or appears to deviate markedly from other values or observations in the sampled population. In one implementation, the UE reports (e.g., via capability reporting signaling) whether the UE is capable of determining and/or removing CSI outliers. In one example, the gNB configures the UE to determine and/or remove the outliers. One motivation may be to get better CSI statistics especially for ultra-reliable low-latency communication (“URLLC”) operation. In some examples, depending on how frequent (e.g., in time domain and/or frequency domain) the CSI measurement resources or CSI-RS and/or CSI-IM transmission occasions are, the UE determines and/or removes the outliers. For instance, if the CSI-RS and/or CSI-IM density is below a threshold, the UE may not determine and/or remove the outliers. In various examples, the UE determines if the statistical CSI is reliable and/or available based on the determined outliers (e.g., based on the number and/or percentage of outliers or the values of the outliers, and so forth). In one example, the UE determines outliers corresponding to wide-band CSI measurements, and not sub-band CSI measurements. In another example, measurements are not considered as outliers for SINR and/or CQI measurements below a threshold.

In some embodiments, a UE reports (e.g., along with reported statistics) a confidence measure of reported CSI statistics or whether there are outliers in computation of the statistics. One motivation may be to help a gNB implementation choose a more conservative MCS and/or transmission parameters for the case that the reported CSI statistics is not very reliable and/or there are outliers in the statistics. In some examples, the confidence measure may be based on the degree of the left-tail of the CQI and/or SINR sample population (e.g., offset from the minimum value of the sample population to the reported CQI and/or SINR value), or the ratio of the offset to the value of the CSI statistic (e.g., standard deviation, in this case how many standard deviations it is from the mean or reported CQI and/or SINR value). In one example, an interquartile range (“IQR”) measure is used to determine the outliers. The IQR is the first quartile (e.g., Q1, defined as the 25th percentile) subtracted from the third quartile (e.g., Q3, defined as the 75th percentile) of the sampled CSIs. In another example, outliers are determined as CSI observations that fall below Q1−u*IQR or above Q3+v*IQR. In a further example, u=v=1.5. In certain examples, ‘u’, ‘v’ can be defined or indicated (e.g., by higher layer signaling).

In a third embodiment, there may be reporting of CSI statistics.

In various embodiments, mean and standard deviation (“std”) of CQI and/or SINR samples are jointly encoded. One motivation of such encoding is to report more useful and/or applicable combinations of mean and/or std.

In certain embodiments, a UE reports two functions of CQI and/or SINR samples, such as (e.g., mean+p*std, mean-q*std). One motivation of such encoding is to report more states and/or code points belonging to reasonable and/or practical SINR and/or CQI range compared to sending mean and/or std even with different scales and granularities for codepoints. In one example, ‘p’ and ‘q’ are indicated by a gNB (e.g., via higher layer signaling or indicated by the UE based on an interference profile, SINR, and/or CQI distribution. In another example, the UE determines ‘p’ and ‘q’ such that mean+p*std<=M (e.g., 30 dB) and mean-q*std>=N (e.g., −5 dB), and report ‘p’ and ‘q’ e.g., along with (mean+p*std, mean-q*std). In a further example, ‘M’ and ‘N’ can be defined or indicated (e.g., by higher layer signaling). In some examples, the UE normalizes the set of SINR and/or CQI samples by a scaling factor for determining the statistical CSI information: wherein the scaling factor is fixed in the specifications and/or configured by higher layer signaling. In one example, the scaling factor can be ‘n’, ‘n+1’, ‘n−1’, ‘n−1.5’ (e.g., for calculating the mean of SINR and/or CQI). In another example, a subset of CQI and/or SINR samples are used to determine statistical CSI such as variance of SINR and/or CQI. In a further example, samples below a mean and/or average SINR and/or CQI are used to determine the variance.

In some embodiments, a UE can indicate to a network if interference, SINR, and/or CQI distribution (e.g., probabilities of occurrence of different possible interference, SINR, and/or CQI sample values) has been changed or if properties and/or characteristics of the distribution have been changed and/or have particular features (e.g., whether the distribution is asymmetric such as with respect to a mean of the distribution, via higher layer signaling or physical layer signaling such as UCI (e.g., in a CSI report)).

In various embodiments, a UE normalizes CSI statistics (e.g., prior to reporting) or SINR and/or CQI samples (e.g., to have reasonable dynamic range) such as by: 1) a beamforming factor: and/or 2) a number of transmission layers.

In a fourth embodiment, there may be processing of CSI statistics.

In certain embodiments, if a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}-L unoccupied CPUs. If N CSI reports start occupying their respective CPUs on the same OFDM symbol on which N_{CPU}-L CPUs are unoccupied, where each CSI report n=0, . . . , N−1 corresponds to O_{CPU}⁽ⁿ⁾, the UE is not required to update the N-M requested CSI reports with lowest priority (according to Clause 5.2.5), where 0≤M≤N is the largest value such that Σₙ₌₀^{M-1} O_{CPU}⁽ⁿ⁾≤N_{CPU}-L holds. For a CSI report with CSI-ReportConfig with higher layer parameter reportQuantity not set to ‘none’, the central processing units (“CPUs”) are occupied for a number of OFDM symbols as follows: 1) a periodic or semi-persistent CSI report (e.g., excluding an initial semi-persistent CSI report on PUSCH after the physical downlink control channel (“PDCCH”) triggering the report) occupies CPUs from the first symbol of the earliest one of each CSI-RS, CSI-IM, and/or SSB resource for channel or interference measurement, respective to a latest CSI-RS, CSI-IM, and/or SSB occasion no later than the corresponding CSI reference resource, until the last symbol of the configured PUSCH and/or PUCCH carrying the report: 2) an aperiodic CSI report occupies CPUs from the first symbol after the PDCCH triggering the CSI report until the last symbol of the scheduled PUSCH carrying the report: and/or 3) an initial semi-persistent CSI report on PUSCH after the PDCCH trigger occupies CPUs from the first symbol after the PDCCH until the last symbol of the scheduled PUSCH carrying the report.

In some embodiments, there may be processing of CSI statistics occupies O_{CPU}=m CPUs from the first symbol of the earliest one of each CSI resources for channel or interference measurement, till latest CSI resource transmission occasion no later than the corresponding CSI reference resource, until the last symbol of the configured PUSCH/PUCCH carrying the report. In an example, ‘m=1’. In another example, ‘m’ is determined based on the number of CSI-RS and/or CSI-IM measurement resources used for calculating the statistics within a window of time (e.g., normalized by the number of OFDM symbols within the window of time). In a further example, ‘m’ is determined based on the calculation method used for CSI statistics (e.g., whether outliers of CSI measurement are determined/removed or not). In some examples, m=Kₛ, where Kₛ is the number of CSI-IM resources in the CSI-IM resource set for interference measurement. In various example, m=Kₛ, where Kₛ is the number of CSI-RS resources in the CSI-RS resource set for channel measurement. In certain examples, m=Kₛ, where Kₛ is the number of CSI-RS and CSI-IM resources respectively in the CSI-RS resource set for channel measurement and CSI-IM resource set for interference measurement. In some of the examples described herein, the ‘m’ value may be scaled by a scaling factor. The scaling factor may be a predetermined value or may be a determined by UE capability signaling. In some examples, the ‘m’ value may not be an integer value (e.g., may be a rational number such as m=½, or m=Kₛ/2).

In various embodiments, processing of CSI statistics occupies O_{CPU}=m1 CPUs from the first symbol of the earliest one of each CSI resources for channel or interference measurement, gradually increasing to O_{CPU}=m2 (>m1) CPUs from the first symbol of the second CSI resources for channel or interference measurement and so on to reach maximum occupation of O_{CPU}=m CPUs after the last CSI resources (e.g., used for statistics) for channel or interference measurement. In one implementation, whether m2>m1 or m>m1 depends on how often CQI and/or SINR is determined (e.g., for the purpose of deriving CSI statistics).

In certain embodiments, processing of CSI statistics occupies O_{CPU}=m CPUs from the first symbol of the last CSI resources (e.g., used for statistics) for channel or interference measurement.

In some embodiments, a UE is configured to report CSI statistics and additional CSI quantities (e.g., such as CQI, PMI, and/or RI), and if the number of available CPUs are not sufficient to process both the CSI statistics and additional CSI quantities, either CSI statistics or additional CSI quantities are processed. In one example, if it is determined that CSI statistics are not reliable, not available, and/or are low-priority, and if the number of available CPUs are sufficient to process either CSI statistics or additional CSI quantities, then the UE is not expected to process report associated with CSI statistics and release CPUs (e.g., if any) that are already occupied for processing CSI statistics and occupy the available CPUs for processing CSI report for additional quantities. In another example, if it is determined that CSI statistics are reliable, available, and/or a high-priority, and if the number of available CPUs are sufficient to process either CSI statistics or additional CSI quantities, then the UE is expected to process a report associated with CSI statistics and not expected to update the CSI report for additional quantities due to unavailability of CPUs. In a further example, for CSI statistics reporting together with other CSI quantities (e.g., such as PMI and/or RI), no additional CPU is needed compared to the CPU needed for reporting the other CSI quantities. For CSI report containing only CSI statistics, some CPU would be needed to process at least the new and/or latest CSI-RS and/or CSI-IMs received since the last full (e.g., containing CQI, PMI, and/or RI) CSI report.

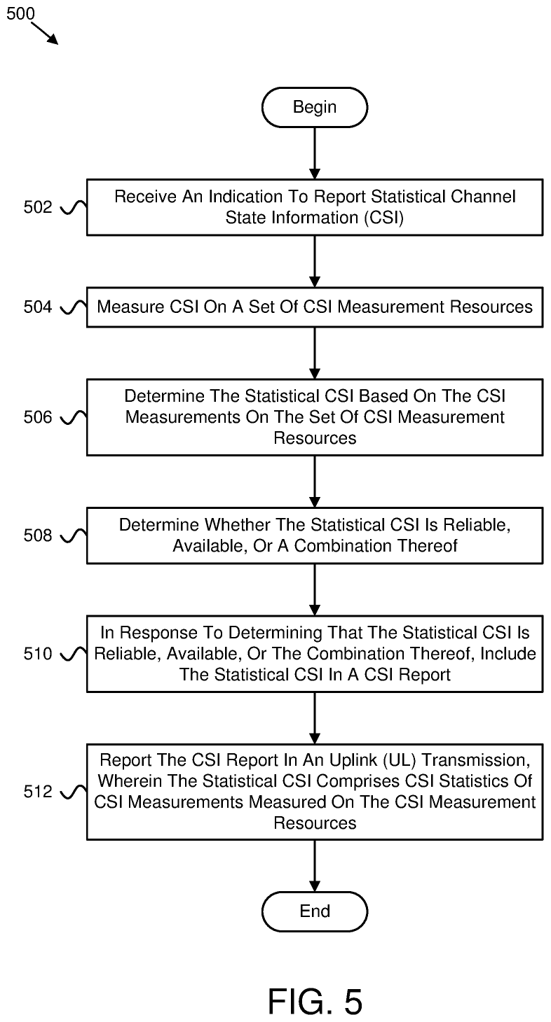

FIG. 5 is a flow chart diagram illustrating one embodiment of a method 500 for reporting statistical channel state information in a report. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502, at a user equipment, an indication to report statistical channel state information (CSI). In some embodiments, the method 500 includes measuring 504 CSI on a set of CSI measurement resources. In certain embodiments, the method 500 includes determining 506 the statistical CSI based on the CSI measurements on the set of CSI measurement resources. In various embodiments, the method 500 includes determining 508 whether the statistical CSI is reliable, available, or a combination thereof. In some embodiments, the method 500 includes, in response to determining that the statistical CSI is reliable, available, or the combination thereof, including 510 the statistical CSI in a CSI report. In certain embodiments, the method 500 includes reporting 512 the CSI report in an uplink (UL) transmission. The statistical CSI includes CSI statistics of CSI measurements measured on the CSI measurement resources.

In certain embodiments, the CSI statistics comprises: a mean of the CSI measurements, a median of the CSI measurements, a percentile of the CSI measurements, a variance of the CSI measurements, a standard deviation of the CSI measurements, or some combination thereof. In some embodiments, in response to determining that the statistical CSI is not reliable, not available, or a combination thereof, indicating to a network device that the statistical CSI is not reliable, not available, or the combination thereof. In various embodiments, in response to determining that the statistical CSI is not reliable, not available, or the combination thereof, not reporting the statistical CSI.

In one embodiment, the statistical CSI is determined to be reliable, available, or the combination thereof in response to a number of valid CSI measurements on the set of CSI measurement resources being greater than or equal to a threshold. In certain embodiments, a CSI measurement is valid in response to the CSI measurement not being an outlier measurement according to an outlier determination measure. In some embodiments, the set of CSI measurement resources comprises CSI measurement resources within a time duration, and the time duration starts from a first time reference and ends at a second time reference.

In various embodiments, the second time reference is a CSI reference resource, and the CSI reference resource determines a latest CSI resource usable to derive the statistical CSI for reporting statistical CSI in the UL transmission. In one embodiment, the first time reference is determined based on a duration and the second time reference. In certain embodiments, the statistical CSI comprises a first function of mean and standard deviation of CSI measurements, and a second function of mean and standard deviation of CSI measurements.

In some embodiments, the set of CSI measurement resources comprises CSI measurement resources no later than a first CSI reference resource. In various embodiments, the method 500 further comprises determining a channel quality indicator (CQI), and including the CQI in the CSI report. In one embodiment, the CQI is determined based on second CSI measurements on a second set of CSI measurement resources including CSI measurement resources no later than a second CSI reference resource, and the first CSI reference resource is earlier than the second CSI reference resource.

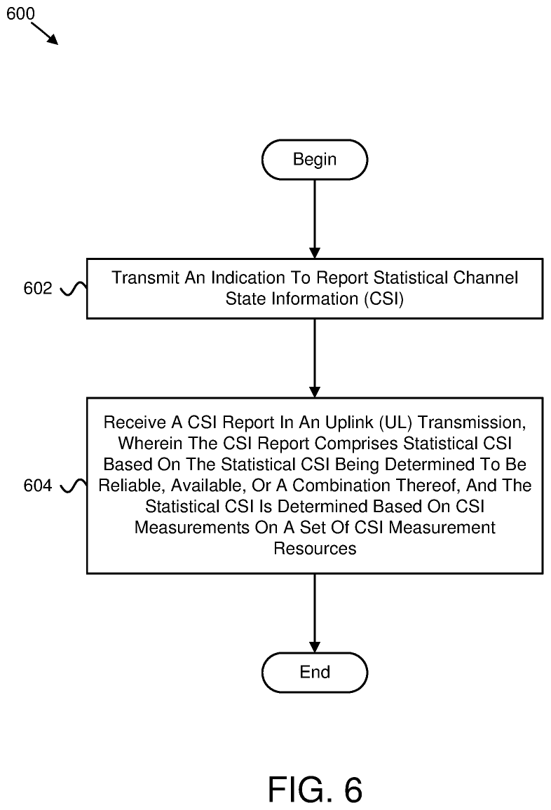

FIG. 6 is a flow chart diagram illustrating another embodiment of a method 600 for reporting statistical channel state information in a report. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602, from a network device, an indication to report statistical channel state information (CSI). In some embodiments, the method 600 includes receiving 604 a CSI report in an uplink (UL) transmission. The CSI report includes statistical CSI based on the statistical CSI being determined to be reliable, available, or a combination thereof, and the statistical CSI is determined based on CSI measurements on a set of CSI measurement resources.

In certain embodiments, the set of CSI measurement resources comprises CSI measurement resources within a time duration, and the time duration starts from a first time reference and ends at a second time reference. In some embodiments, the second time reference is a CSI reference resource, and the CSI reference resource determines a latest CSI resource usable to derive the statistical CSI for reporting statistical CSI in the UL transmission. In various embodiments, the first time reference is determined based on a duration and the second time reference.

In one embodiment, the statistical CSI comprises a first function of mean and standard deviation of CSI measurements, and a second function of mean and standard deviation of CSI measurements. In certain embodiments, the set of CSI measurement resources comprises CSI measurement resources no later than a first CSI reference resource.

In one embodiment, an apparatus comprises a user equipment (UE). The apparatus further comprises: a receiver that receives an indication to report statistical channel state information (CSI): a processor that: measures CSI on a set of CSI measurement resources: determines the statistical CSI based on the CSI measurements on the set of CSI measurement resources: determines whether the statistical CSI is reliable, available, or a combination thereof: and, in response to determining that the statistical CSI is reliable, available, or the combination thereof, includes the statistical CSI in a CSI report: and a transmitter that reports the CSI report in an uplink (UL) transmission, wherein the statistical CSI comprises CSI statistics of CSI measurements measured on the CSI measurement resources.

In certain embodiments, the CSI statistics comprises: a mean of the CSI measurements, a median of the CSI measurements, a percentile of the CSI measurements, a variance of the CSI measurements, a standard deviation of the CSI measurements, or some combination thereof.

In some embodiments, in response to determining that the statistical CSI is not reliable, not available, or a combination thereof, indicating to a network device that the statistical CSI is not reliable, not available, or the combination thereof.

In various embodiments, in response to determining that the statistical CSI is not reliable, not available, or the combination thereof, not reporting the statistical CSI.

In one embodiment, the statistical CSI is determined to be reliable, available, or the combination thereof in response to a number of valid CSI measurements on the set of CSI measurement resources being greater than or equal to a threshold.

In certain embodiments, a CSI measurement is valid in response to the CSI measurement not being an outlier measurement according to an outlier determination measure.

In some embodiments, the set of CSI measurement resources comprises CSI measurement resources within a time duration, and the time duration starts from a first time reference and ends at a second time reference.

In various embodiments, the second time reference is a CSI reference resource, and the CSI reference resource determines a latest CSI resource usable to derive the statistical CSI for reporting statistical CSI in the UL transmission.

In one embodiment, the first time reference is determined based on a duration and the second time reference.

In certain embodiments, the statistical CSI comprises a first function of mean and standard deviation of CSI measurements, and a second function of mean and standard deviation of CSI measurements.

In some embodiments, the set of CSI measurement resources comprises CSI measurement resources no later than a first CSI reference resource.

In various embodiments, the processor determines a channel quality indicator (CQI), and including the CQI in the CSI report.

In one embodiment, the CQI is determined based on second CSI measurements on a second set of CSI measurement resources including CSI measurement resources no later than a second CSI reference resource, and the first CSI reference resource is earlier than the second CSI reference resource.

In one embodiment, a method at a user equipment (UE) comprises: receiving an indication to report statistical channel state information (CSI): measuring CSI on a set of CSI measurement resources: determining the statistical CSI based on the CSI measurements on the set of CSI measurement resources: determining whether the statistical CSI is reliable, available, or a combination thereof; in response to determining that the statistical CSI is reliable, available, or the combination thereof, including the statistical CSI in a CSI report: and reporting the CSI report in an uplink (UL) transmission, wherein the statistical CSI comprises CSI statistics of CSI measurements measured on the CSI measurement resources.

In certain embodiments, the CSI statistics comprises: a mean of the CSI measurements, a median of the CSI measurements, a percentile of the CSI measurements, a variance of the CSI measurements, a standard deviation of the CSI measurements, or some combination thereof.

In some embodiments, in response to determining that the statistical CSI is not reliable, not available, or a combination thereof, indicating to a network device that the statistical CSI is not reliable, not available, or the combination thereof.

In various embodiments, in response to determining that the statistical CSI is not reliable, not available, or the combination thereof, not reporting the statistical CSI.

In one embodiment, the statistical CSI is determined to be reliable, available, or the combination thereof in response to a number of valid CSI measurements on the set of CSI measurement resources being greater than or equal to a threshold.

In certain embodiments, a CSI measurement is valid in response to the CSI measurement not being an outlier measurement according to an outlier determination measure.

In some embodiments, the set of CSI measurement resources comprises CSI measurement resources within a time duration, and the time duration starts from a first time reference and ends at a second time reference.

In various embodiments, the second time reference is a CSI reference resource, and the CSI reference resource determines a latest CSI resource usable to derive the statistical CSI for reporting statistical CSI in the UL transmission.

In one embodiment, the first time reference is determined based on a duration and the second time reference.

In certain embodiments, the statistical CSI comprises a first function of mean and standard deviation of CSI measurements, and a second function of mean and standard deviation of CSI measurements.

In some embodiments, the set of CSI measurement resources comprises CSI measurement resources no later than a first CSI reference resource.

In various embodiments, the method further comprises determining a channel quality indicator (CQI), and including the CQI in the CSI report.

In one embodiment, the CQI is determined based on second CSI measurements on a second set of CSI measurement resources including CSI measurement resources no later than a second CSI reference resource, and the first CSI reference resource is earlier than the second CSI reference resource.

In one embodiment, an apparatus comprises a network device. The apparatus further comprises: a transmitter that transmits an indication to report statistical channel state information (CSI): and a receiver that receives a CSI report in an uplink (UL) transmission, wherein the CSI report comprises statistical CSI based on the statistical CSI being determined to be reliable, available, or a combination thereof, and the statistical CSI is determined based on CSI measurements on a set of CSI measurement resources.

In certain embodiments, the set of CSI measurement resources comprises CSI measurement resources within a time duration, and the time duration starts from a first time reference and ends at a second time reference.

In some embodiments, the second time reference is a CSI reference resource, and the CSI reference resource determines a latest CSI resource usable to derive the statistical CSI for reporting statistical CSI in the UL transmission.

In various embodiments, the first time reference is determined based on a duration and the second time reference.

In one embodiment, the statistical CSI comprises a first function of mean and standard deviation of CSI measurements, and a second function of mean and standard deviation of CSI measurements.

In certain embodiments, the set of CSI measurement resources comprises CSI measurement resources no later than a first CSI reference resource.

In one embodiment, a method at a network device comprises: transmitting an indication to report statistical channel state information (CSI): and receiving a CSI report in an uplink (UL) transmission, wherein the CSI report comprises statistical CSI based on the statistical CSI being determined to be reliable, available, or a combination thereof, and the statistical CSI is determined based on CSI measurements on a set of CSI measurement resources.

In certain embodiments, the set of CSI measurement resources comprises CSI measurement resources within a time duration, and the time duration starts from a first time reference and ends at a second time reference.

In some embodiments, the second time reference is a CSI reference resource, and the CSI reference resource determines a latest CSI resource usable to derive the statistical CSI for reporting statistical CSI in the UL transmission.

In various embodiments, the first time reference is determined based on a duration and the second time reference.

In one embodiment, the statistical CSI comprises a first function of mean and standard deviation of CSI measurements, and a second function of mean and standard deviation of CSI measurements.

In certain embodiments, the set of CSI measurement resources comprises CSI measurement resources no later than a first CSI reference resource.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive an indication to report statistical channel state information (CSI);
measure CSI on a set of CSI measurement resources;
determine the statistical CSI based on the CSI measurements on the set of CSI measurement resources;
determine whether the statistical CSI is reliable, available, or a combination thereof;
in response to determining that the statistical CSI is reliable, available, or the combination thereof, include the statistical CSI in a CSI report; and
report the CSI report in an uplink (UL) transmission, wherein the statistical CSI comprises CSI statistics of CSI measurements measured on the CSI measurement resources.

2. The UE of claim 1, wherein the CSI statistics comprises: a mean of the CSI measurements, a median of the CSI measurements, a percentile of the CSI measurements, a variance of the CSI measurements, a standard deviation of the CSI measurements, or a combination thereof.

3. The UE of claim 1, wherein the at least one processor is configured to cause the UE to, in response to determining that the statistical CSI is not reliable, not available, or a combination thereof, indicate to a network device that the statistical CSI is not reliable, not available, or the combination thereof.

4. The UE of claim 3, wherein the at least one processor is configured to cause the UE to, in response to determining that the statistical CSI is not reliable, not available, or the combination thereof, not report the statistical CSI.

5. The UE of claim 1, wherein the statistical CSI is determined to be reliable, available, or the combination thereof in response to a number of valid CSI measurements on the set of CSI measurement resources being greater than or equal to a threshold.

6. The UE of claim 5, wherein a CSI measurement is valid in response to the CSI measurement not being an outlier measurement according to an outlier determination measure.

7. The UE of claim 1, wherein the set of CSI measurement resources comprises CSI measurement resources within a time duration, and the time duration starts from a first time reference and ends at a second time reference.

8. The UE of claim 7, wherein the second time reference is a CSI reference resource, and the CSI reference resource determines a latest CSI resource usable to derive the statistical CSI for reporting statistical CSI in the UL transmission.

9. The UE of claim 8, wherein the first time reference is determined based on a duration and the second time reference.

10. The UE of claim 1, wherein the statistical CSI comprises a first function of mean and standard deviation of CSI measurements, and a second function of mean and standard deviation of CSI measurements.

11. The UE of claim 1, wherein the set of CSI measurement resources comprises CSI measurement resources no later than a first CSI reference resource.

12. The UE of claim 11, wherein the at least one processor is configured to cause the UE to determine a channel quality indicator (CQI) and include the CQI in the CSI report.

13. The UE of claim 12, wherein the CQI is determined based on second CSI measurements on a second set of CSI measurement resources including CSI measurement resources no later than a second CSI reference resource, and the first CSI reference resource is earlier than the second CSI reference resource.

14. A processor for wireless communication, comprising:
at least one controller coupled with at least one memory and configured to cause the processor to:
receive an indication to report statistical channel state information (CSI);
measure CSI on a set of CSI measurement resources;
determine the statistical CSI based on the CSI measurements on the set of CSI measurement resources;
determine whether the statistical CSI is reliable, available, or a combination thereof;
in response to determining that the statistical CSI is reliable, available, or the combination thereof, include the statistical CSI in a CSI report; and
report the CSI report in an uplink (UL) transmission, wherein the statistical CSI comprises CSI statistics of CSI measurements measured on the CSI measurement resources.

15. An apparatus for performing a network function, the apparatus comprising:
at least one memory; and
at least one processor coupled with the at least one memory and configured to cause the apparatus to:
transmit an indication to report statistical channel state information (CSI); and
receive a CSI report in an uplink (UL) transmission, wherein the CSI report comprises statistical CSI based on the statistical CSI being determined to be reliable, available, or a combination thereof, and the statistical CSI is determined based on CSI measurements on a set of CSI measurement resources.

16. The processor of claim 14, wherein the CSI statistics comprises: a mean of the CSI measurements, a median of the CSI measurements, a percentile of the CSI measurements, a variance of the CSI measurements, a standard deviation of the CSI measurements, or a combination thereof.

17. The processor of claim 14, wherein the at least one controller is configured to cause the processor to, in response to determining that the statistical CSI is not reliable, not available, or a combination thereof, indicate to a network device that the statistical CSI is not reliable, not available, or the combination thereof.

18. The processor of claim 17, wherein the at least one controller is configured to cause the processor to, in response to determining that the statistical CSI is not reliable, not available, or the combination thereof, not report the statistical CSI.

19. The processor of claim 14, wherein the statistical CSI is determined to be reliable, available, or the combination thereof in response to a number of valid CSI measurements on the set of CSI measurement resources being greater than or equal to a threshold.

20. A method at a user equipment (UE), the method comprising:
receiving an indication to report statistical channel state information (CSI);
measuring CSI on a set of CSI measurement resources;
determining the statistical CSI based on the CSI measurements on the set of CSI measurement resources;
determining whether the statistical CSI is reliable, available, or a combination thereof;
in response to determining that the statistical CSI is reliable, available, or the combination thereof, including the statistical CSI in a CSI report; and
reporting the CSI report in an uplink (UL) transmission, wherein the statistical CSI comprises CSI statistics of CSI measurements measured on the CSI measurement resources.
